(19) United States
(12) Patent Application Publication
(10) Pub. No.: US 2008/0304254 A1
(43) Pub. Date: Dec. 11, 2008

(54) Self-powered flashlight/lantern

(75) Inventors: Serafino S. Canino, Torrington, CT (US); Scott Gelormino, Burlington, CT (US)

Correspondence Address: BROWN RUDNICK LLP, ONE FINANCIAL CENTER, BOSTON, MA, 02111, US

(73) Assignee: ICC Innovative Concepts, Corp., Canton, CT (US)

(21) Appl. No.: 11/811,287

(22) Filed: Jun. 8, 2007

(51) Int. Cl. F21L 4/00; F21S 4/00; F21V 19/02; F21V 21/088; F21V 21/096

(52) U.S. Cl. 362/183; 362/220; 362/368; 362/372

(57) ABSTRACT

An illuminating device including a housing, at least one LED located within said housing, a grip handle, wherein the grip handle comprises a first shell and a second shell, wherein the first shell and the second shell join together, a rotatable shaft, coupled to the grip handle and to the housing, wherein the rotatable shaft comprises a spindle and a belt that rotates along the spindle to rotate the grip handle and the housing in a twisting motion against one another, an electric generating device received in a cavity of the grip handle, and an actuating device including a follower rotatably attached to the grip handle, including a handle pivotally attached to the follower for rotating the follower relative to the grip handle, and including a knob rotatably attached to the handle, to allow the handle to be rotated relative to the grip handle, wherein the actuating device and the electric generating device generate electric energy to energize the illuminating device.

### FIELD OF THE INVENTION

The present invention relates to a self-powered illuminating device, and more particularly, a self-powered illuminating device with flashlight and lantern illuminating members connected by a spindle and collar coupling to a deflectable handle to facilitate ergonomic and/or stable use of the same under a variety of conditions.

### BACKGROUND OF THE INVENTION

Typical illuminating devices are lanterns and/or flashlights that require either batteries or an AC voltage source. The inability to adjust the position and orientation of a flashlight and/or a lantern can be inconvenient. Typically, lanterns are designed to be placed on a table for illumination of an area such as a work area, for example, for reading, eating or the like. Alternatively lanterns may be hung or placed on a high object.

In principal, ordinary flashlights may be used for work area illumination. In such uses, typically, the user places a flashlight in a stable position, aimed as closely as possible to a particular work area.

In the past, attempts have been made to improve the flexibility of lighting devices. For example, the bendable flashlight with a central portion which may be bent around, for example, a pipe, which is made by Black & Decker and sold under the trademark Snakelight, represents an attempt to provide a lantern function in a flashlight. This flashlight generally comprises an illumination end, and an elongated opposite gooseneck portion, which may be secured around any desired object. If desired, for example, such a light may be rotated around a stay or a mast on a boat and the light aimed to provide general illumination, or illumination of a particular work task.

### SUMMARY OF THE INVENTION

There are also several functional limitations for hands-free and hand-held uses associated with prior art flashlights and/or lanterns. Illuminating devices known in the art can usually be hand-held in an upright position, or can be placed on their base. This is a problem because it requires the light to be placed on a stable and relatively flat, horizontal surface, which is not always available or convenient.

One embodiment of the present invention is an illuminating device including several elements. The illuminating device includes a light source housing. The device also includes at least one LED located within the housing and a grip handle. The grip handle includes a first shell and a second shell, and the first shell and the second shell join together and define a collar at one end. The device also includes a rotatable shaft, defined on the light source housing. The shaft is coupled to the spindle on the grip handle of the housing. The collar rotates on the spindle to rotate the grip handle relative to the light source housing in a twisting motion. Alternatively, the collar may be provided on the light source housing and the spindle provided on the grip handle. The device also optionally includes an electric generating device received in a cavity of the grip handle. An actuating device including a follower coupling rotatably attached to the grip handle, including a handle pivotally attached to the follower for rotating the follower relative to the grip handle. A knob is rotatably attached to the handle, to allow the handle to be rotated relative to the grip handle, and couple rotary motion to the electric generating device to generate electric energy to energize the illuminating device.

In accordance with the preferred embodiment of the present invention an illuminating device has a lantern and a headlamp. The illuminating device includes a body having: an elongated handle with a hand grip, for example on the grip handle, and a housing portion joining and extending laterally from an end of the elongated handle to have a distal end with respect to the elongated handle. The illuminating device also includes at least one rechargeable battery accommodated in the handle, a rotatable driving shaft extending from a distal end of the handle, with a spindle for rotating said elongated handle against said housing portion, a first recess and a second recess in the housing portion, wherein the first recess is at an end of the housing portion and the second recess is alongside the driving shaft, one LED received in the first recess and connectable to the battery, wherein the one LED is the headlamp. At least one LED is received in the second recess and connectable to the battery, wherein the at least one LED is the lantern.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a side perspective view of an illuminating device fully rotated in accordance with the present invention;

FIG. 2 is an angled side perspective view of an illuminating device fully rotated in accordance with the present invention;

FIG. 3 is an angled back perspective view of an illuminating device in a straight position in accordance with the present invention;

FIG. 4 is an angled front perspective view of an illuminating device in a straight position in accordance with the present invention;

FIG. 5 is a back perspective view of an illuminating device in a straight position in accordance with the present invention;

FIG. 6 is a first side perspective view of an illuminating device in a straight position in accordance with the present invention;

FIG. 7 is a front perspective view of an illuminating device in a straight position in accordance with the present invention;

FIG. 8 is a second side perspective view of an illuminating device in a straight position in accordance with the present invention;

FIG. 9 is a top perspective view of an illuminating device in accordance with the present invention;

FIG. 10 is a bottom perspective view of an illuminating device in accordance with the present invention;

FIG. 11 is a front perspective view of an illuminating device in a straight position illustrating a function;

FIG. 12 is a back perspective view of an illuminating device in a straight position illustrating its function; and

FIG. 13 is a perspective view of the rotating mechanism;

FIG. 14 is a schematic cross-sectional view illustrating the spindle and collar mechanism; and

FIG. 15 is a schematic of an electrical circuit for operating the inventive illuminating device 10.

### DETAILED DESCRIPTION

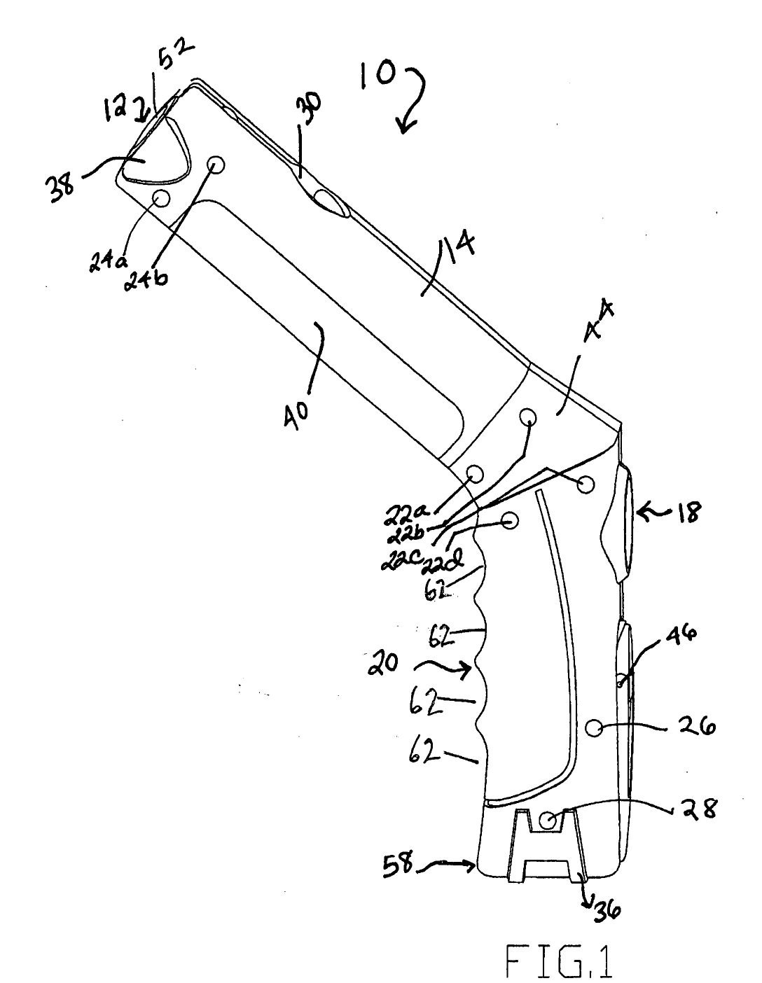

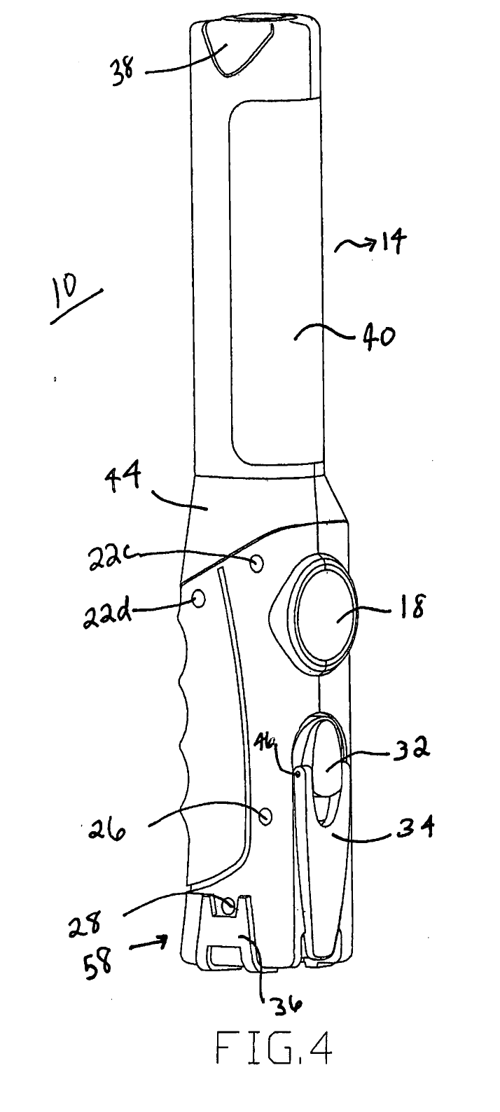

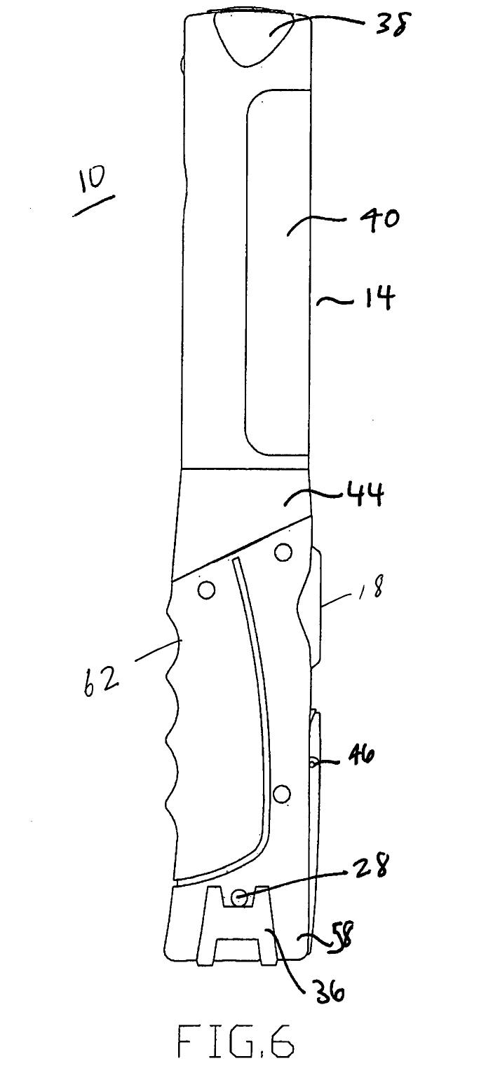

With reference to the figures, FIGS. 1-10 illustrate an illuminating device constructed in accordance with the present invention. An illuminating device 10 includes a headlamp 12, more clearly shown in FIG. 9. In this embodiment, the headlamp 12 comprises, for example, a single light bulb 52 which emits a direct beam of light. The headlamp 12 is located at the front end of illuminating device 10, and is mounted in an illuminator housing 14. The housing 14 of the illuminating device 10 has a concave divot 38 where the headlamp 12 is located and placed.

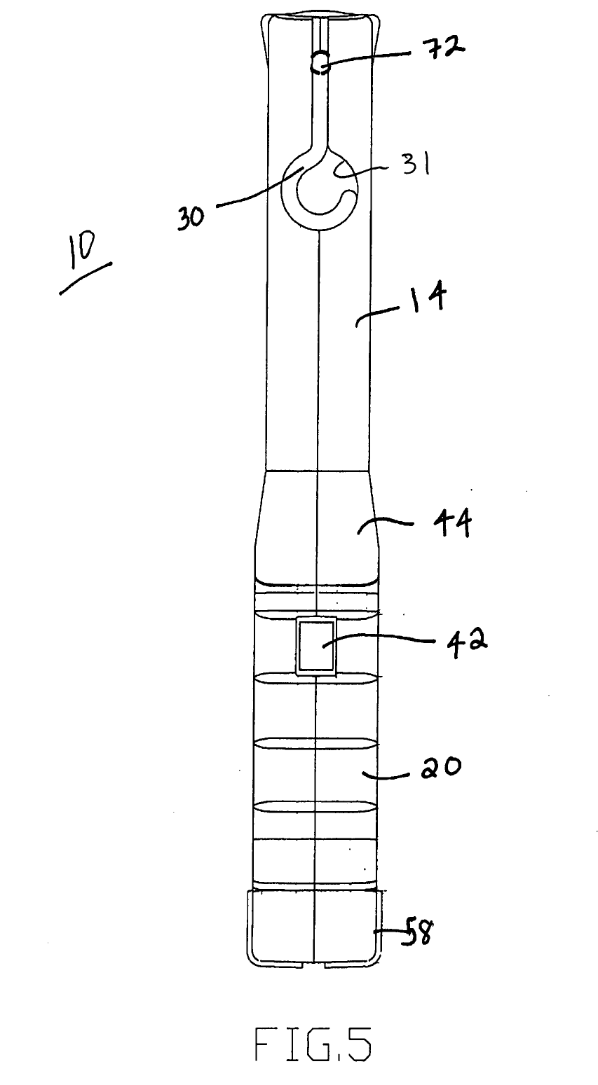

The housing 14, which is attached to a rotating member 44, includes a plurality of LEDs making up a lantern 40 of the illuminating device 10. The rear of the illuminating device 10 is shown in FIG. 5. As can be seen in this figure, a hook 30 is mounted in a recess 31 of the housing 14.

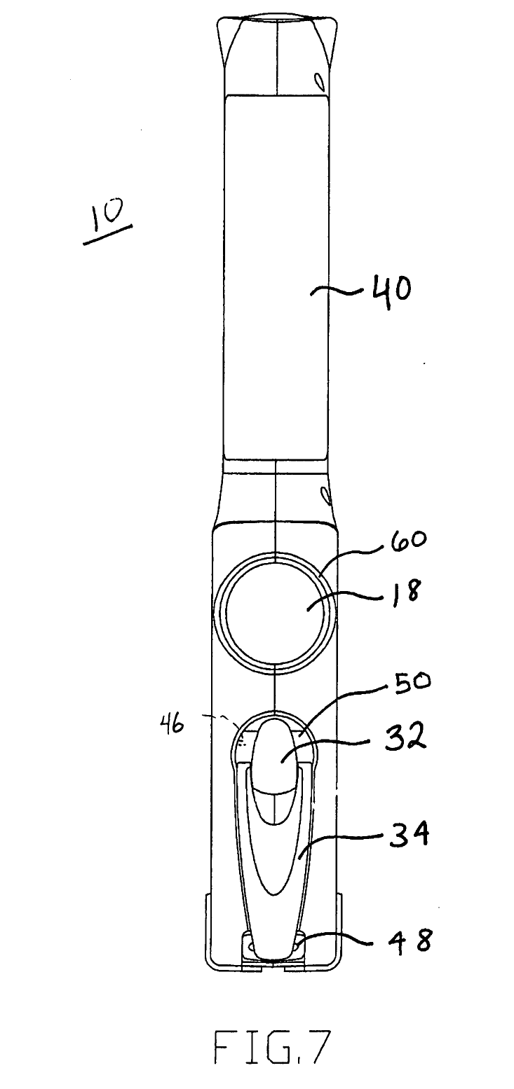

The handle 20 includes indentations 62 to provide an easy grip for a user on the illuminating device 10, as can be seen in FIGS. 1-4, 6 and 8. The front side of the illuminating device 10 is shown in FIG. 7. Here, there is a magnet holder mounting 60, where a magnet 18 is positioned. The magnet 18 in this embodiment is glued to the magnet holder mounting 60, however the magnet could also be attached using a metal screw, a plastic screw, or any other means to attach the magnet to the handle. The magnet 18 is used to attach the illuminating device 10 to a magnetic surface, for example iron or steel, like a refrigerator, or the hood of a car. When one is doing mechanical work under the hood of a car, for example, one can attach the illuminating device 10 to the hood, using the magnet 18, for a continuous light source. If such a use, the flashlight may be configured as illustrated in FIG. 1, thus providing for general illumination of the engine.

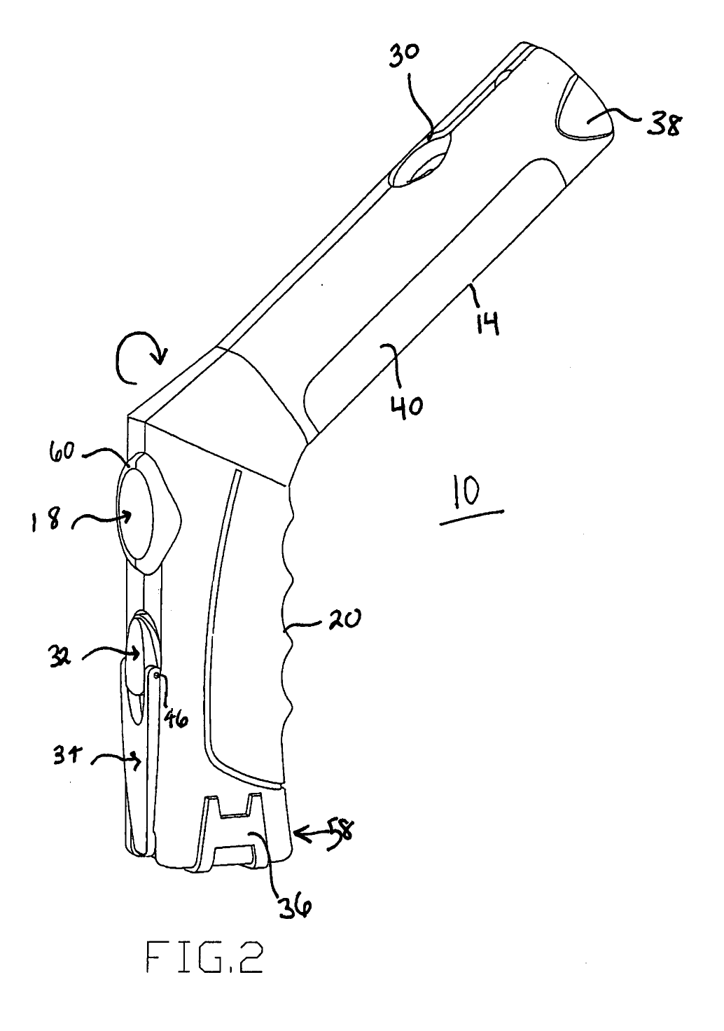

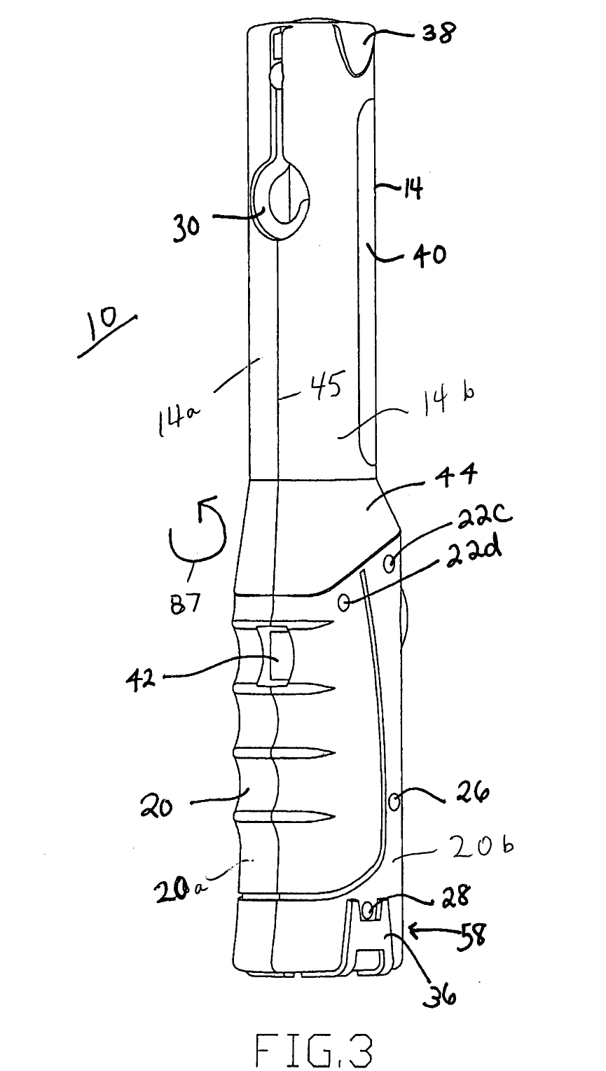

In accordance with one embodiment of the invention, a charging device 50 (FIG. 7) is positioned on the side of illuminating device 10. Charging device 50 includes a follower coupling 32 and a crank 34 having one end pivotally secured to the follower coupling 32 by a shaft 46, as shown in FIGS. 2, 4, 7 and 11. The grip of the illuminating device 10, as shown in FIGS. 3 and 5, includes a switch 42.

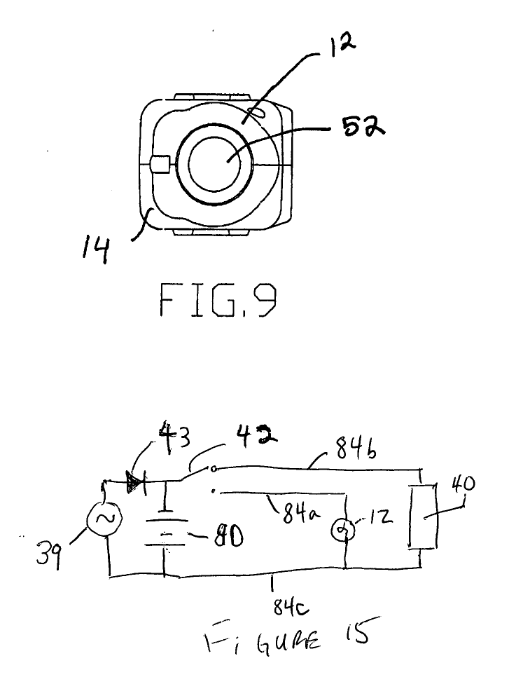

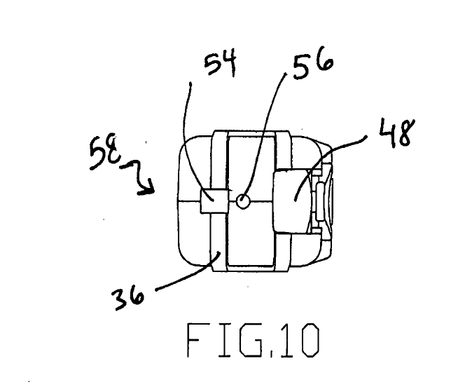

The base 58 of the illuminating device 10 is shown in FIG. 10. Here, the base 58 includes a connector 54 configured to receive the output of an AC voltage charger and an indicator light 56, which indicates when charging is occurring. Alternatively, the indicator light may be used to indicate the state of charge of an already charge battery. Still another alternative is blinking or other drives of indicator light 56 to indicate various things including charging and state of charge. The base 58 also includes a divot 48 and a support member 36 (FIGS. 1-4, 6, 8 and 10).

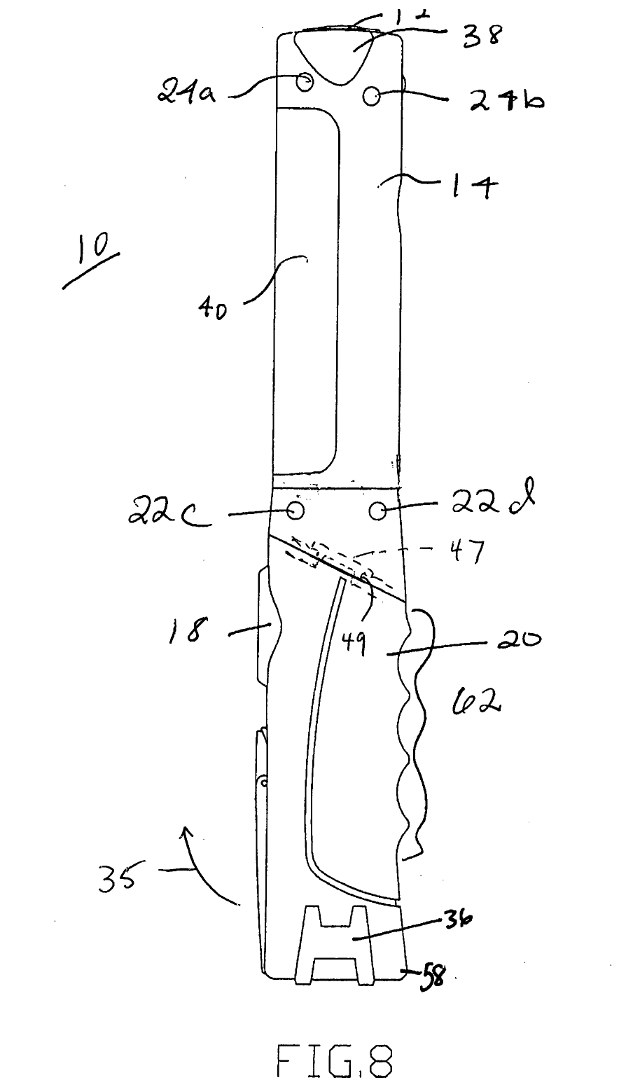

When it is desired to charge a rechargeable battery contained in illuminating device 10, the crank is rotated from the position shown in FIG. 8 in the direction of arrow 35 to the position illustrated in solid lines in FIG. 11. Crank 34 is then rotated on on pin 46 relative to follower 32 to bring handle 20 from the folded or storing position, illustrated in FIG. 1 an open or working position illustrated in FIG. 11. A knob 48 may be rotatably secured to the other end of the crank 34 with a fastener 70, to allow the follower 32 to be easily gripped for rotation, for example in the direction indicated by arrow 37, relative to the handle 20. Typically this may be done by grasping the crank 34 by holding the knob 48. As shown in FIG. 11, the crank may be rotated around 360 degrees continuously, either clockwise or counterclockwise.

An electrical circuit for operating the event of illuminating device 10 is illustrated in FIG. 15. An electrical generator 39 may be located within the handle 20 and mechanically coupled to coupling follower 32. The actuating device 50 and the electrical generator 39 are mechanically coupled to one another in order to generate and supply energy to a storage battery 80. Storage battery 80 is connected by a coupling circuit, for example a rectifier circuit 43, two the headlamp 12 and to the lantern illumination assembly 40. Lantern illumination assembly 40 may be, for example, an array of five, ten, twenty, or even more light emitting diodes. Power may be switched between headlamp 12 and lantern illumination assembly 40 by a selector switch 42 or any other suitable device.

It is noted that the present invention does not require the use of a generator. Other means of producing energy may be used with the present invention, for example, a rechargeable battery 80 may be the charged by house current or a car battery.

In the preferred embodiment, the switch 42, as seen in FIGS. 3 and 5, can perform three functions. The switch 42 can turn the headlamp 12 on, or it can turn the lantern 40 on, or it can turn the illuminating device 10, including both the headlamp 12 and the lantern 40, off. However, a switch with any number of functions may be used with the present invention.

Returning to FIG. 10, the indicator light 56 lights up if the illuminating device 10 is receiving power in some embodiments, or is charged in other embodiments. In yet another embodiment, the emitting light 56 indicates that the illuminating device 10 needs more power to operate. The divot 48 is an opening in the base 58 for the knob 48 to snap in and be held in place. Support member 36 (FIGS. 1-4, 6, 8 and 10) provides a stable platform at the base 58 so that the illuminating device 10 may stand upright easily.

The housing 14 which holds the lantern element 40 may be injection molded in two halves 14a, 14b, and assembled with the elements bearing against each other at an interface 45. As illustrated in FIG. 8, each of these halves are joined to one another via fasteners 24a, 24b, 22a and 22b. In this embodiment, the fasteners are metal screws, however these two halves may be attached using glue, plastic screws, metal screws, or any other way where the two halves are joined.

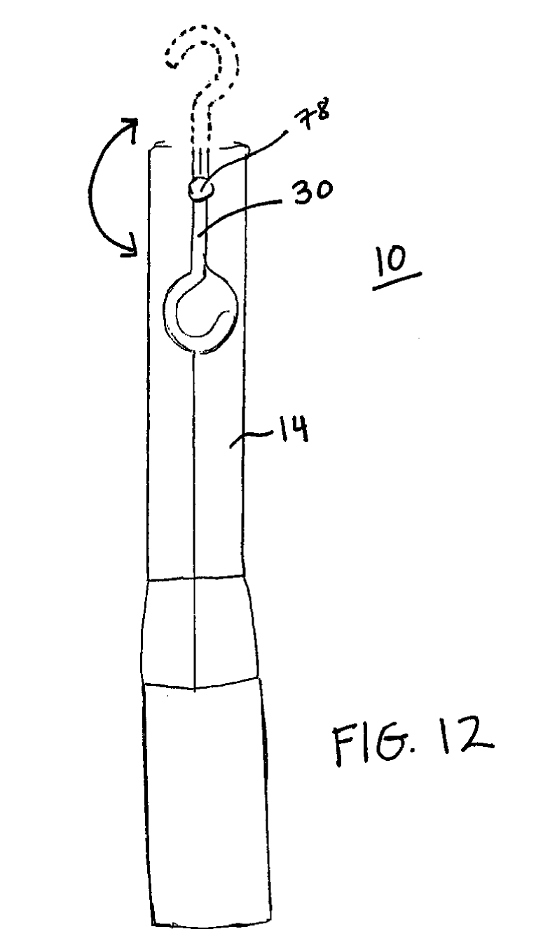

Housing 14, as illustrated in FIG. 13, includes a spindle 47 which defines a race 49. See also FIG. 8. Race 49 on spindle 47 is engaged by a collar 67, as described below.

The handle 20 comprises a first shell 20a and a second shell 20b. The first shell and the second shell are joined together, in this embodiment, by screws 22c, 22d, 26 and 28. Any other fastening means may be used, like glue or any other mechanism. Each of the first shell and the second shell cover half of a spindle each, located in the rotating mechanism 44. The first shell 20a and a second shell 20b

Power is coupled from storage battery 82 illuminator housing 14 by a plurality of wires, as will be described below. The rotating element is restrained from rotating 360 degrees; for example it can rotate just short of the 360 degrees, to a maximum of approximately 350 degrees. The less than full 360 degree rotation prevents rotation from continuing in one direction unchecked, the wires within from being twisted, broken or damaged.

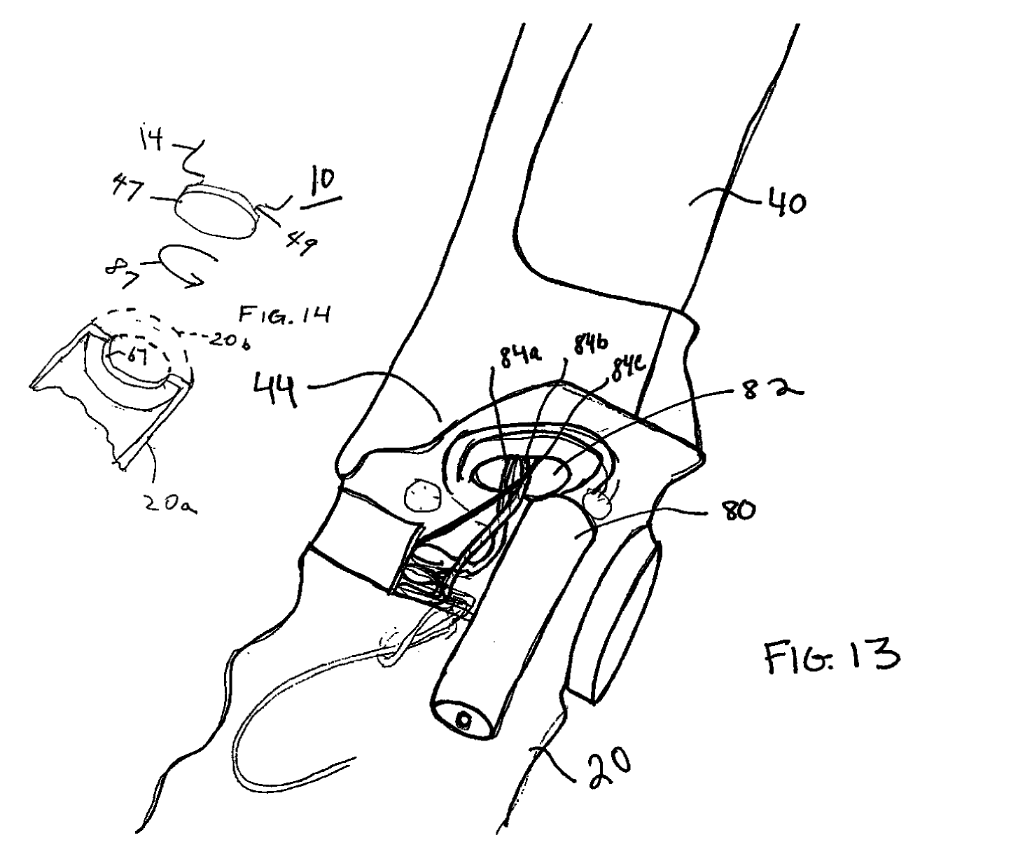

Turning to FIGS. 13-14, a first wire 84a conducts the electricity to actuate the headlamp 12, a second wire 84b conducts the electricity to light the lantern 40, and a third wire 84c is a common or a ground. The rotating device 44 is coupled to the handle 20.

As alluded to above, rather than the illuminating device 10 being operated by a generator 50 charging a battery, the illuminating device 10 may also be operated using a non-rechargeable battery(s), a charger that is plugged into the wall, AC voltage, DC voltage, or a charger that is plugged into the cigarette lighter in a car or any other device.

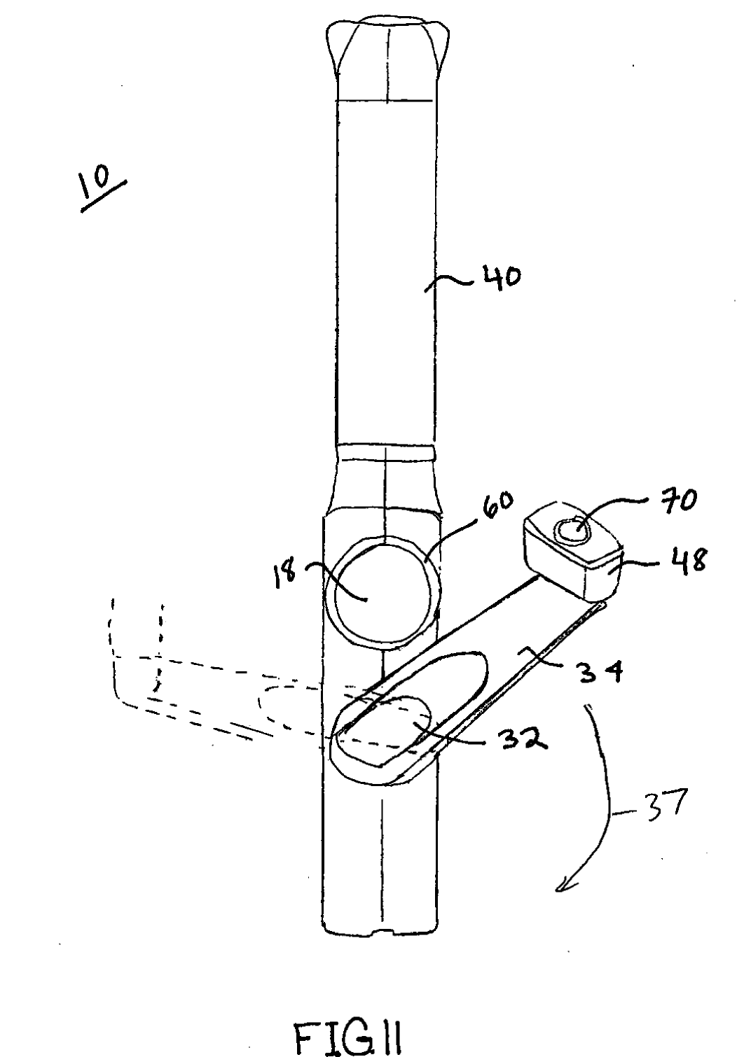

In another embodiment (FIG. 12), the hook 30 is shown in a resting position and in a hanging position. The hook comprises a ball 78, which is part of a ball and socket mounting, that can be rotated approximately 180 degrees in three dimensions, enabling the hook to go from resting position within the housing 14 to a hanging position, as shown in FIG. 12. The hook 30 can be used to hang the illuminating device 10 and allows the illuminating device 10 to be used as a hanging light, for example using lantern light 40.

What is desired to operate the inventive light, crank 34 is rotated from the position, illustrated, for example, in FIG. 2 to the physician illustrated in solid lines in FIG. 11. Generally the operation of crank type rechargeable flashlights is known. Plus, the crank is rotated in the direction indicated by arrow 37, for example. This is done until the battery is charged. Alternatively, the batteries may be charged by coupling a recharging power supply to connector 54. Once the battery has been sufficiently charged, switch 42 may be operated to turn on the light in the desired fashion.

As alluded to above, the inventive light may be hung by causing magnet 18 to engage a magnetic surface, such as steel or iron. For example, magnet 18 may be engaged with a steel tent pole to provide general illumination inside a tent. Alternatively, magnet 18 may engage the side of a car to illuminate an area beside the car or provide a reading light for an individual sitting in the car seat with his legs extending from the car. Yet another alternative is to thank the inventive light 10 through the use of hook 30. In either case, the flashlight/lantern 10 of the present invention may be placed either in the configuration illustrated in FIG. 1 or the configuration illustrated in FIG. 3. Such configuration is selected by rotation, for example in the direction of arrow 87, as illustrated in FIGS. 3 and 13.

Such rotation allows the grip handle and the housing to rotate with respect to each other, to positions with are oriented at an angle to each other. This is achieved because rotation is permitted by the collar and spindle arrangement about a rotation axis at an angle between 15° and 75°, but preferably about 45°, with respect to the axis of the inventive device 10 as illustrated in FIG. 3. It is noted that the device may be hung or used in either the FIG. 1 position or the FIG. 3 position. Intermediate positions may provide various advantages with securement by magnet 18 or hook 30.

In addition to the description of specific, non-limited examples of embodiments of the invention provided herein, it should be appreciated that the invention can be implemented in numerous other applications involving the different configurations of video-processing equipment. Although the invention is described hereinbefore with respect to illustrative embodiments thereof, it will be appreciated that the foregoing and various other changes, omissions and additions in the form and detail thereof may be made without departing from the spirit and scope of the invention.

What is claimed is:

1. An illuminating device comprising:
(a) a illuminator housing;
(b) at least one LED located within said housing;
(c) a grip handle; and
(d) a rotatable mounting, coupled to said grip handle and to said housing, for allowing said grip handle and said housing to rotate with respect to each other, said rotatable mounting being oriented for rotation about a rotation axis at an angle between 15° and 75° with respect to the access of said the illuminator housing and/or said grip handle to vary the angular relationship between said housing and said grip handle.

2. At illuminating device further comprising a support member, secured to said grip handle or said housing for supporting said illuminating device.
Further comprising:
(e) an energy generating device received in a cavity of said grip handle; and
(f) an charging device including a follower rotatably attached to said grip handle, including a handle pivotally attached to said follower for rotating said follower relative to said grip handle, and including a knob rotatably attached to said handle, to allow said handle to be rotated relative to said grip handle, wherein said actuating device and said energy generating device generate energy to energize said illuminating device.

3. An illuminating device as in claim 1, wherein said grip handle comprises a first shell and a second shell, wherein said first shell and said second shell join together.

4. An illuminating device as in claim 1, wherein said rotatable mounting comprises a spindle and a collar that rotates on said spindle to rotate said grip handle with respect to said housing in a twisting motion against one another.

5. The apparatus of claim 1, wherein said rotatable shaft rotates in a range between 0 degrees and 350 degrees.

6. The apparatus of claim 1 further comprising:
a headlamp at a distal end of said housing.

7. The apparatus of claim 1 further comprising:
a magnet attached to an outer surface of said grip handle for attaching said illuminating device to a magnetic surface.

8. The apparatus of claim 1 further comprising:
a hook attached to said housing for hanging said illuminating device.

9. The apparatus of claim 1, wherein at least one rechargeable battery is accommodated in said grip handle.

10. The apparatus of claim 1 further comprising:
a switch for operating said at least one LED, wherein said switch is located on said grip handle.

11. The apparatus of claim 1, wherein said housing is twisted in a clockwise direction from said grip handle.

12. The apparatus of claim 1, wherein said housing is twisted in a counterclockwise direction from said grip handle.

13. The apparatus of claim 1, wherein said energy generating device generates electric energy.

14. An illuminating device as in claim 1, further comprising a hook mounted for rotation with respect to said illuminating device.

15. An illuminating device as in claim 1, wherein said illuminator housing comprises an elongated illuminator housing, and a plurality of light sources are disposed along they surface of said illuminator housing extending along a length of said illuminator housing.

16. An illuminating device having a lantern and a headlamp comprising:
(a) a body having:
(i) an elongated handle with a hand grip; and
(ii) a housing portion joining and extending laterally from an end of said elongated handle to have a distal end with respect to said elongated handle;
(b) at least one rechargeable battery accommodated in said handle;
(c) a rotatable driving shaft extending from a distal end of said handle with a spindle for rotating said elongated handle against said housing portion;
(d) a first recess and a second recess in said housing portion, wherein said first recess is at an end of said housing portion and said second recess is alongside said driving shaft;
(e) one LED received in said first recess and connectable to said battery, wherein said one LED is said headlamp; and
(f) at least one LED received in said second recess and connectable to said battery, wherein said at least one LED is said lantern.

17. The illuminating device of claim 16, wherein said body further includes:
(a) a magnet.

18. The illuminating device of claim 16, wherein said body further includes:
(a) a self-crank device.

19. The illuminating device of claim 16, wherein said body further includes:
(a) an AC power outlet.

20. The illuminating device of claim 16, wherein said body further includes:
(a) a power indicator light.

21. The illuminating device of claim 16, wherein said housing includes a hook for hanging said illuminating device.

22. An illuminating device comprising:
(a) a housing;
(b) at least one LED located within said housing;
(c) a grip handle, wherein said grip handle comprises a first shell and a second shell, wherein said first shell and said second shell join together; and
(d) a rotatable shaft, coupled to said grip handle and to said housing, wherein said rotatable shaft comprises a spindle and a belt that rotates along said spindle to rotate said grip handle and said housing in a twisting motion against one another.

23. The illuminating device of claim 22, further comprising:
(a) an energy generating device received in a cavity of said grip handle; and
(b) an actuating device including a follower rotatably attached to said grip handle, including a handle pivotally attached to said follower for rotating said follower relative to said grip handle, and including a knob rotatably attached to said handle, to allow said handle to be rotated relative to said grip handle, wherein said actuating device and said energy generating device generate energy to energize said illuminating device.

24. The illuminating device of claim 22, wherein energy provided to said at least one LED is from a battery.

25. The illuminating device of 22, wherein energy provided to said at least one LED is from an AC voltage source.
